(19) United States
(12) Patent Application Publication
(10) Pub. No.: US 2002/0073174 A1
(43) Pub. Date: Jun. 13, 2002

(54) System and method to create a customized internet site

(76) Inventors: Matthew W. Mengerink, Austin, TX (US); Joshua A. Pesikoff, Austin, TX (US); Cena A. Pohl, Brooklyn Heights, NY (US); David J. Wilson, Austin, TX (US)

Correspondence Address: ROTHWELL, FIGG, ERNST & MANBECK, P.C., 1425 K STREET, N.W., SUITE 800, WASHINGTON, DC, 20005, US

(21) Appl. No.: 09/734,043

(22) Filed: Dec. 12, 2000

Related U.S. Application Data
(60) Provisional application No. 60/170,762, filed on Dec. 15, 1999.

(51) Int. Cl. G06F 15/16

(52) U.S. Cl. 709/219

(57) ABSTRACT

A system is provided for allowing a user to customize an Internet web site having several features. This system includes an Internet server that controls the web site. The system further includes a web page-forming component that creates a personal web page for incorporating one or more of the web site features. The personal web page is created in response to an input provided by the user. The personal page has a private component that is accessible only by the user and a public component that is accessible to anyone. The user's input determines which web site features appears in the personal page. The user's input also determines which of the features appear in the private component and which of the features appears in the public component.

### CROSS REFERENCE TO RELATED APPLICATION

This application claims the benefit of the filing date of provisional application Serial No. 60/170,762, filed Dec. 15, 1999.

### BACKGROUND OF THE INVENTION

1. Field Of The Invention

The present invention relates to network communications and, more particularly, to a system and method to create a customized Internet site.

1. Background and Conventional Art

The Internet is becoming an increasingly important source of information. For example, a user may search the Internet for information on a commercial product. During the search, the user may find information from a manufacturer describing the product's features or information from a vendor describing the pricing and availability of the product. Moreover, a key feature of the Internet is its ability to allow unaffiliated people to communicate with each other. Thus, the user researching a product may find useful relevant information from other people on the Internet. The product information may include reviews, personal experiences pertaining to problems with the product, comparisons with competing products, etc. This type of information is often found on Usenet newsgroups, which are Internet forums for the exchange of ideas related to particular topics. Similarly, several Internet sites provide product reviews by their customers. Some Internet sites even combine the information from several sources such as the Usenet and reviewing web sites. Thus there exists a tremendous amount of information on the Internet for the researching user.

One problem related to this amount of information is storing and organizing it. Thus, some sites allow the user to create a private page to store the researched information. For example, some Internet vendors allow customers to store product information for future reference. However, the user can generally only store information from the particular vendor hosting the site. The user cannot combine and store product information from multiple sites.

Another problem with the prior art is that a user may not easily access another person's previous research. In particular, the sites containing research often limit access to the original researcher. Thus, the same search may be performed repeatedly by different users. At the same time, the user may wish to preserve some anonymity and limit the ability of other researchers to access her work. For example, the user may not wish to reveal certain personal facts such as her address.

Still another problem with the present state of technology is that information comes from unknown sources. The user has little ability to check the reliability or reputation of the information source. This problem is compounded by the large volume of information on the Internet. Often, there exists contradicting information and opinions relating to the same subject matter. Thus, the user has to select one of the sources upon which to rely, but without some context to help choose between the sources, the user's choice may be no better than a guess. A better system would allow the user to gain some biographical information in order to better select information sources.

### SUMMARY OF THE INVENTION

Accordingly, to address these needs, the present invention provides a system for allowing a user to customize an Internet web site having several features. This system includes an Internet server that controls the web site. The system further includes a web page-forming component that creates a personal page for incorporating one or more of the web site features. The personal page is created in response to an input provided by the user. The personal page has a private component that is accessible only by the user and a public component that is accessible by anyone. The user's input determines which web site features appear in the personal page. The user's input also determines which of the features appear in the private component and which of the features appear in the public component.

Preferably, the user includes some biographical information in the input to be included in the public component. This information allows researchers to judge the comments/information contained in the public component.

In one embodiment, the system further includes a single-action construction component, whereby the user may add additional web site features to the personal page with a single action, such as clicking a pointing device (e.g., a mouse). In this way, the user may easily add any aspect of the web site to the personal site.

In another embodiment, the system further includes an annotation component that allows the user to create and store a comment related to one or more of the features. For example, the user may comment that a particular function is especially useful. The comment may be accessed later to assist in using the feature. The user may select whether the annotation appears in the public/and or private components.

In another embodiment, the server may allow a third party to access the public component from the web site in a single action.

The web page forming component may further include a construction component to guide the user through the formation of the personal site. For example, the construction component may be a program that allows the user to select with a click of a mouse items to be placed into the private and/or public components.

In another embodiment, the system optionally contains a tracking component that monitors activities in one or more of the features of the web site. Then the tracking component may update the personal site to reflect the activities on the web site.

### BRIEF DESCRIPTION OF THE DRAWINGS

The invention will be more clearly understood from the following detailed description in connection with the accompanying drawings in which:

FIG. 1 is a block diagram of a system to create a customized Internet site in accordance with an embodiment of the present invention; and

FIG. 2 is a flow chart showing the steps of a method to create a customized Internet site in accordance with an embodiment of the present invention.

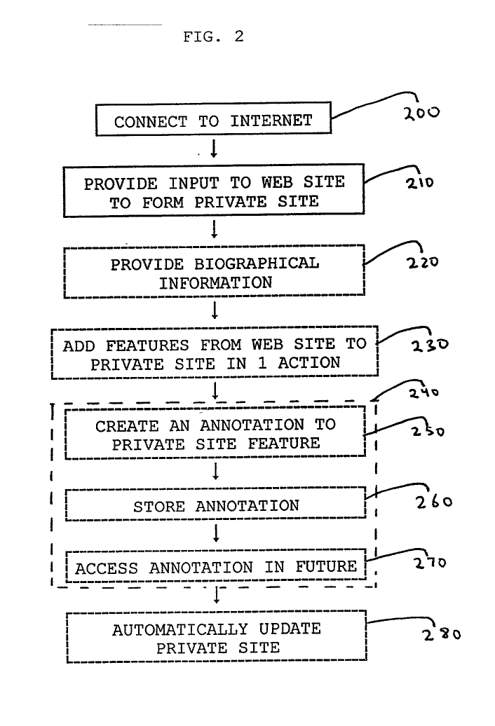

### DETAILED DESCRIPTION OF THE PREFERRED EMBODIMENTS

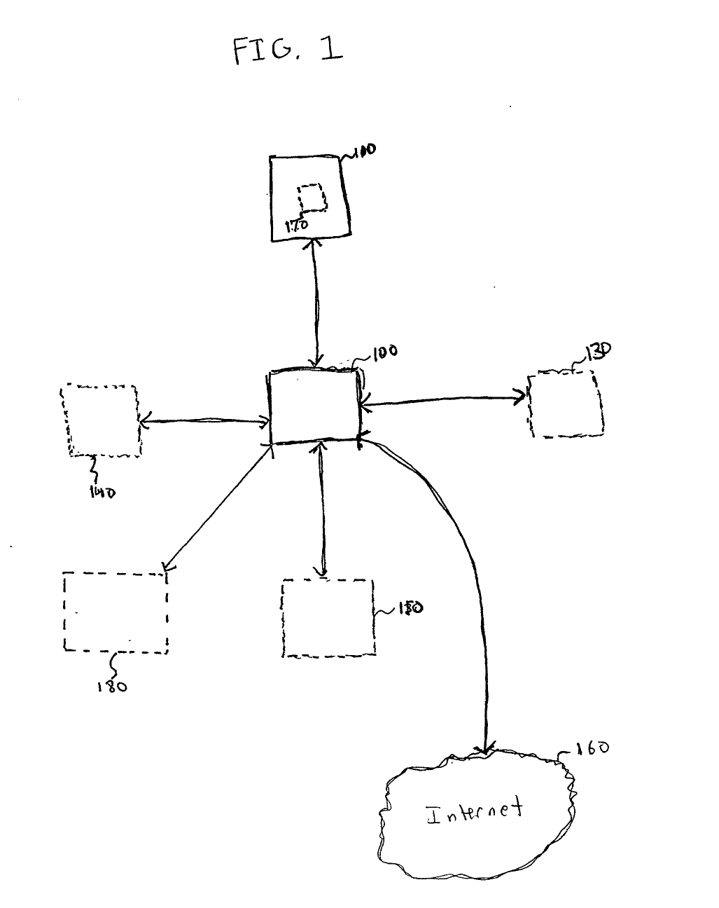

The present invention provides a system for allowing a user to create a customized personal web page. As illustrated in the block diagram FIG. 1, a system in accordance with an embodiment of the present invention is implemented over the Internet 160. One element of the system, server 100, controls the operation of a web site. In particular, the server 100 controls the transfer of data between the server 100 and the Internet 160.

A user may access the web site over the Internet 160. In particular, the user sends a request to the server 100 to begin the transfer of information. This information is used by the user's browser program to display the details of the web site. The web site typically includes features, special aspects and functions that attract people to the web site. For example, the web site may link the user to other sites or newsgroups. Other features will be discussed subsequently.

However, the user may not desire all of the features of the web site. To create a customized personal site containing only the desired features, the user sends an input signal to the server 100. In response to this signal, the system initiates a web page forming component 110 that creates a personal site for incorporating the user's desired web site features. The web page forming component 110 is a computer program that uses the user's input to form the new personal site. Among the jobs of the web-forming component 110 is to have the desired features present in the personal site link to the original web site. The contents of the personal site may vary greatly, according to the user's inputs, but all features must link back to the original web site to operate properly.

The server 100 may monitor the web forming component 110 to see which features are commonly used by the user. In this way, the server may discover which features browsers desire. Using this information, the server 100 may update the web site to provide more of the demanded features and to remove unpopular features. In this way, the server 100 uses the user's input to improve itself.

The web site may require certain information from the user as part of the input. For example, the user may be required to provide personal information such as her age, race, education, etc. The server 100 may use this demographic information to adjust the web site to better meet the needs to the surveyed audience. Alternatively, this information may be used to market the web site to advertisers by showing the presence of desired customers among the registered users.

A key feature of the present invention is that the personal site has a private component that is accessible only by the user and a public component that is accessible to anyone. The user's input determines which web site features appears in the personal site. More particularly, the user's input determines which of the features appear in the private component and which of the features appears in the public component. All of the chosen features may appear in both components. Alternatively, user may choose to have no public component.

The typical private page may contain an index organizing features in the page, access to Internet forums, information regarding the user's Internet community memberships, access to ratings of various types of desired items, bookmarks to link to other Internet sites, links to discussion newsgroups, recent postings and ratings in desired topics, a list of preferred products and reliable sources, etc. The personal page may further include other features such as a calendar, access to e-mail through the web site, or access to an Internet search engine. However, it should be appreciated that numerous other objects may be included in the personal component, and the list of possible features is limited only by the server 100.

Similarly, the public component contains items for anyone to see. The list of potential items in the public component might include, for example, an index organizing features in the public page, access to Internet forums used by the user, information on the user's Internet community memberships, access to ratings of various types of desired items selected by the user, bookmarks to link to other Internet sites, links to discussion news-groups, recent postings and ratings in desired topics, a profile of the user, a wish list of the user's desired items, a virtual ‘storefront’ showing recommended items, a list of reliable sources, etc.

On future visits to the web site, the user may choose to use the personal page rather than using the general web site. The user may access the personal page through the web site. For example, the web site may have a button on which the user clicks to reach the personal page (such as by logging on as a registered user). The user then needs to identify herself to gain access to the personal page. For example, the user may provide an access code. Alternatively, the user's browser may contain an identifying code in the form of a ‘cookie.’ The web page may also transfer the user to the personal web page after she takes certain actions or uses certain features. In this way, the server 100 may encourage the user to add certain features to the personal site.

Similarly, other users of the web site have the option of viewing the user's public page or component of the user's personal page. For example, a third party may access a user's public site by clicking on the user's name. The user's name may appear, for example, when the user has posted information for others to read. By looking at the user's public component, the third party may gain the necessary additional knowledge in order to assess the user's information.

For this reason, it is preferable for the user to include some biographical information in the input used to form the public component of the user's personal page. For example, the user may discuss the source for her information. This information gives personal information about the user to other users and allows the other users to judge the opinions and information contained in the public component. For example, a user who is an avid bicyclist is more likely to have the experience and knowledge to provide good information on different types of bicycles.

In one embodiment, the web page-forming component 110 further includes an optional construction component 170 to guide the user through the formation of the personal site. For example, the construction component 170 may be a program that allows the user to select with a click of a mouse items to be placed into the private and/or public components. Such a program could be written in JAVA or PERL and sent to the user's browser to run.

In another embodiment, the system further includes an annotation component 150 that allows the user to create and store a comment related to one or more of the features. For example, the user may comment that a particular function is especially useful. Then, the comment may be viewed later to assist the user in using the feature. The annotation component 150 allows the user to annotate any item or feature. The annotation is stored in a database, along with a pointer that indicates the subject for the annotation.

The user selects whether the annotation is to appear in the public/and or private components. If the user wishes to note a fact for later personal use, the user may employ the annotation component 150 to add a comment to be stored in the private component. For example, the user may summarize an article and attach the summary to the article to avoid having to reread the article in the future. If the user wishes to share information, the user may place an annotation on the public component. For example, the user may comment that a particular Internet site was especially helpful. As can be seen in this last example, the user can comment on items not resident on the user's personal page, but viewed through the web site. The annotation is associated with the address or link, rather than the actual contents.

In another embodiment, the server may allow a third party to access the public component from the web site in a single action. For example, as described above, a user may click on the registered user's name to access the public component of her personal page.

In one embodiment, the system further includes a single-action construction component 140 through which the user may add additional web site features to the personal page with a single action, such as clicking the mouse. In this way, the user easily may add any aspect of the web site to her personal page. The single-action construction component 140 is generally a program that runs in connection with the server 100. In this way, the single-action construction component 140 may initiated at any point in the web site controlled by the server 100.

For example, the web site may contain a button on every page to allow the user to add some or all of the contents of the displayed page to the personal page. When the user clicks on the button, the single-action construction component 140 starts, noting the location of the displayed page and adding a connection to the displayed page in the personal page. Alternatively, the single-action construction component 140 may copy the contents of the displayed page and store these contents in one of the components of the personal page.

In another embodiment, the system optionally contains a tracking component 180 that monitors activities in one or more of the features of the web site. The tracking component 180 is a program that monitors changes by comparing a present state of a feature to a former state. The tracking component 180 may automatically update the personal site to reflect the activities in the features. Alternatively, the tracking component 180 may notify the user of the activity. For example, when the web site receives a new review of a desired product, the tracking component 180 may add the contents of the new review to the personal site or may add notice of the new review to the personal site.

The tracking component 180 may be initiated by a command of the user. Alternatively, the tracking component may operate automatically as a function of the web site. In this capacity, the tracking component may, for example, automatically alert the user of newly available features or changes in the existing features.

In another embodiment, the present invention provides a method for allowing a user to customize an Internet web site having desired features. In step 200, the user connects to a server via the Internet to access the web site. Then, as described above, the user provides an input to the web site via the Internet at step 210. This input initiates a web page-forming component that forms a personal page incorporating one or more of the web site features in accordance with the input. As in the above-described system, the personal page has a private component accessible only by the user and a public component accessible to anyone. The user's input determines which of the features appear in the private component and which of the features appear in the public component.

In optional step 220, the user provides biographical information to be included in the public component. As described above, this provides a context in which other viewers can form judgments about the user's comments.

The user may also add one or more of the web site features to the personal page with a single action at (optional) step 230. As described above, the user may use the single action construction component 140.

The user optionally may add annotation to the material in the personal page, at step 240. This step involves creating an annotation related to one of the features in the personal page, at step 250; storing the annotation, at step 260; and accessing the annotation during subsequent use of the personal page, at step 270.

In optional step 280, the contents of the personal site is automatically updated to reflect activities or changes in the web site.

The invention having been described, it will be apparent to those skilled in the art that the same may be varied in many ways without departing from the spirit and scope of the invention. Any and all such modifications are intended to be included in the scope of the following claims.

What is claimed is:

1. A system for allowing a user to customize an Internet web site having predetermined features, the system comprising:
a server that is connected to the Internet and that controls the web site; and
a web page-forming component for forming a personal web page incorporating one or more of the features in response to an input provided by the user via the Internet, said personal web page comprising a private component accessible only by the user and a public component accessible to anyone, wherein the user's input determines which of the features appear in the private component and which of the features appears in the public component.

2. The system of claim 1 wherein the input further provides biographical information on the user to be included in the public component.

3. The system of claim 1 further comprising a single action construction component, wherein the user may add one or more of the web site features to the personal web page with a single action.

4. The system of claim 1 further comprising an annotation component that allows the user to create and store a comment related to one of the features in the personal web page, such that the comment may be later accessed.

5. The system of claim 1, wherein the server allows a third party to access the public component from the web site in a single action.

6. The system of claim 1 wherein the web page-forming component further comprises a construction component to guide the user through the formation of the personal site.

7. The system of claim 1 further comprising a tracking component that changes the personal web page to reflect changes in the web site.

8. A method for allowing a user to customize an Internet web site having particular features, the method comprising the steps of:
connecting to a server via the Internet to access the web site;
providing an input to the web site via the Internet, wherein said input initiates a web page-forming component for forming a personal web page incorporating one or more of the web site features in accordance with the input, said personal web page comprising a private component accessible only by the user and a public component accessible to anyone, wherein the input determines which of the features appear in the private component and which of the features appears in the public component.

9. The method of claim 8 further comprising providing biographical information to be included in the public component.

10. The method of claim 8 further comprising adding one of the web site features to the personal web page with a single action.

11. The method of claim 8 further comprising the steps of:
creating an annotation related to one of the features in the personal web page;
storing said annotation; and
accessing said annotation during subsequent use of the personal web page.

12. The method of claim 8 further comprising the step of automatically updating the personal web page.
